(19) United States
(12) Patent Application Publication
(10) Pub. No.: US 2020/0152150 A1
(43) Pub. Date: May 14, 2020

(54) DRIVE CIRCUIT OF DISPLAY PANEL AND METHODS THEREOF AND DISPLAY DEVICE

(71) Applicants: CHONGQING ADVANCE DISPLAY TECHNOLOGY RESEARCH, Chongqing (CN); Chongqing HKC Optoelectronics Technology Co., Ltd., Chongqing (CN)

(72) Inventor: Xiaoyu Huang, Chongqing (CN)

(21) Appl. No.: 16/454,038

(22) Filed: Jun. 26, 2019

Related U.S. Application Data
(63) Continuation of application No. PCT/CN2018/118901, filed on Dec. 3, 2018.

(30) Foreign Application Priority Data
Nov. 9, 2018 (CN) 201811336050.1

(51) Int. Cl. G09G 3/36

(52) U.S. Cl. CPC G09G 3/3677; G09G 3/3696; G09G 2300/0809; G09G 2310/08; G09G 2320/0233; G09G 3/3614

(57) ABSTRACT

Disclosed is a drive circuit for a display panel. When receiving the first timing control signal, the gate drive circuit performs a chamfered depressurization on a gate turn-on voltage of a driving power supply output to a gate drive circuit to control a capacitor charging voltage of a previous row of sub-pixels in two adjacent rows as a first predetermined voltage; when receiving the second timing control signal, the gate drive circuit performs a chamfered depressurization on the gate turn-on voltage of the driving power supply output to the gate drive circuit.

### CROSS REFERENCE TO RELATED APPLICATIONS

This application is a Continuation Application of PCT Application No. PCT/CN2018/118901 filed on Dec. 3, 2018, which claims the benefit of a Chinese patent application No. 201811336050.1 titled “DRIVE CIRCUIT OF DISPLAY PANEL AND METHODS THEREOF AND DISPLAY DEVICE” applied on Nov. 9, 2018, the disclosure of which is incorporated herein by reference in its entirety.

### FIELD OF THE DISCLOSURE

This application relates to the field of LCD driving technology, and in particular, to a drive circuit of a display panel and methods thereof, and a display device.

### BACKGROUND OF THE DISCLOSURE

At present, in the design of the Dual-gate of the liquid crystal display panel, in order to ensure high pixel charging rate and good image quality of the panel, the Dual-gate usually uses 1+2 line or 2 Line Inversion to drive the polarity inversion of the capacitors in the pixel array.

However, this inversion method may cause the charging efficiency of two adjacent pixels to be inconsistent due to the excessive voltage across the data voltage, resulting in a bright and dark line problem, resulting in a degradation of the image quality of the liquid crystal display panel.

### SUMMARY OF THE DISCLOSURE

The main purpose of the present application is to propose a display circuit of a display panel and methods thereof, aimed at improving the image quality of the display device.

To achieve the above purpose, the present application proposes a drive circuit of a display panel, the display panel having a plurality of sub-pixels; wherein the drive circuit of the display panel includes:

a timing controller configured to output a first timing control signal and a second timing control signal;

a driving power supply configured to output gate turn-on voltage and/or gate turn-off voltage;

a gate drive circuit configured to receive a gate turn-on voltage of the driving power supply to drive corresponding even-numbered rows and odd-numbered rows of sub-pixels to operate in the Dual-gate;

A chamfered circuit configured to, when receiving the first timing control signal, perform a chamfered depressurization on a gate turn-on voltage of the driving power output to the gate drive circuit to control a capacitor charging voltage of a previous row of sub-pixels in two adjacent rows as a first predetermined voltage; when receiving the second timing control signal, the gate drive circuit performs a chamfered depressurization on the gate turn-on voltage of the driving power supply output to the gate drive circuit to control a capacitor charging voltage of a subsequent row of sub-pixels in two adjacent rows to be equal to the first predetermined voltage.

Optionally, the chamfered circuit includes a first chamfered resistor, a second chamfered resistor, a first switch tube and a second switch tube. A first end of the first chamfered resistor is an input end of the chamfered circuit, and is connected to a first end of the second chamfered resistor. A second end of the first chamfered resistor is interconnected with an input end of the first switch tube and an output end of the second switch tube respectively. The output end of the first switch tube is grounded, and the controlled end of the first switch tube is the first controlled end of the first chamfered circuit; a second end of the second chamfered resistor is connected to an input end of the second switch tube, and an controlled end of the second switch tube is a second controlled end of the chamfered circuit.

Optionally, the number of the first chamfered resistors is plural, and a plurality of the first chamfered resistors are arranged in parallel.

Optionally, the first switch tube and/or the first switch tube are N-MOS transistors.

Optionally, the first switch tube and/or the first switch tube are N-MOS triodes.

Optionally, the first switch tube and/or the first switch tube are IGBT (Insulated Gate Bipolar Transistor).

The present application further proposes a display device including a Dual-gate having a plurality of odd-numbered rows and a plurality of even-numbered rows of sub-pixels, a timing controller, and a driving power supply, wherein the display device further includes the gate drive circuit of the display device as described above;

a gate drive circuit configured to receive a gate turn-on voltage of the driving power supply to drive a corresponding row of sub-pixels to operate in the Dual-gate;

a chamfered circuit configured to, when receiving the first timing control signal, perform a chamfered depressurization on a gate turn-on voltage output to the gate drive circuit by the driving power to control a capacitor charging voltage of a current row of sub-pixels as a first predetermined voltage; when receiving the second timing control signal, the gate drive circuit performs a chamfered depressurization on the gate turn-on voltage output to the gate drive circuit by the driving power supply to control a capacitor charging voltage of an even-numbered row of sub-pixels to be equal to the first predetermined voltage.

Optionally, the Dual-gate comprises a switch array; the drive circuit of the display panel further comprises a plurality of data lines and a plurality of scanning lines electrically connected to the gate drive circuit, and the switch array comprises a plurality of thin film transistors. The thin film transistors of the odd-numbered columns in each row are respectively connected to the odd-numbered rows of scanning lines, and the thin-film transistors of the even-numbered columns in each row are electrically connected to the even-numbered rows of scanning lines respectively, and adjacent odd-numbered columns of thin film transistors and the even-numbered columns of thin film transistors are electrically connected to the same data line.

Optionally, the Dual-gate comprises a switch array; the drive circuit of the display panel further includes a plurality of data lines and a plurality of scanning lines electrically connected to the gate drive circuit, and the switch array includes a plurality of thin film transistors. The thin film transistors of the odd-numbered columns in each row are respectively connected to the odd-numbered rows of scanning lines, and the thin-film transistors of the even-numbered columns in each row are electrically connected to the even-numbered rows of scanning lines respectively, and adjacent odd-numbered columns of thin film transistors and the even-numbered columns of thin film transistors are electrically connected to the same data line.

Optionally, the way of the polarity inversion of the switch array is a 1+2 Line Inversion.

Optionally, the way of the polarity inversion of the switch array is a 2 Line Inversion.

Optionally, a plurality of the scanning lines include odd-numbered rows of scanning lines and even-numbered rows of scanning lines.

Optionally, the display device further includes a source drive circuit, and the timing controller is connected to the gate drive circuit, the source drive circuit, and the driving power supply respectively.

Optionally, the driving power supply is integrated with a plurality of DC-DC conversion circuits of different circuit functions, each of the DC-DC conversion circuits outputting a different voltage value.

Optionally, the chamfered circuit includes a first chamfered resistor, a second chamfered resistor, a first switch tube and a second switch tube. A first end of the first chamfered resistor is an input end of the chamfered circuit, and is connected to a first end of the second chamfered resistor. A second end of the first chamfered resistor is interconnected with an input end of the first switch tube and an output end of the second switch tube respectively. The output end of the first switch tube is grounded, and the controlled end of the first switch tube is the first controlled end of the first chamfered circuit; a second end of the second chamfered resistor is connected to an input end of the second switch tube, and an controlled end of the second switch tube is a second controlled end of the chamfered circuit.

Optionally, the number of the first chamfered resistors is plural, and a plurality of the first chamfered resistors are arranged in parallel.

Optionally, the first switch tube and/or the first switch tube are N-MOS transistors.

Optionally, the display device is a computer display/mobile phone/monitor/television.

The present application further proposes a driving method of a display panel, and the display panel includes a plurality of sub-pixels and the driving method of the display panel includes:

when receiving the first timing control signal, performing a chamfered depressurization on a received gate turn-on voltage to control a capacitor charging voltage of a previous row of sub-pixels in two adjacent rows as a first predetermined voltage;

when receiving the second timing control signal, performing a chamfered depressurization on a received gate turn-on voltage to control a capacitor charging voltage of a subsequent row of sub-pixels in two adjacent rows to be equal to the first predetermined voltage.

Optionally, the step of performing a chamfered depressurization on the gate turn-on voltage output to the gate drive circuit includes:

performing different levels of voltage division on the gate turn-on voltage output to the gate drive circuit according to the received first timing control signal or the second timing control signal, to perform a chamfered depressurization on the gate turn-on voltage.

In the present application, when the timing controller outputs a control signal to the gate drive circuit, and when the driving power outputs the gate turn-on voltage to the gate drive circuit to drive the gate drive circuit to operate, the timing controller outputs the first timing control signal and the second timing control signal to the chamfered circuit respectively to control the chamfered circuit to perform a chamfered depressurization on the gate turn-on voltage. Therefore, in the process that the gate drive circuit outputs the corresponding row scanning signal to the thin film transistor via the row scanning line to realize the row-by-row opening from the first row scanning line to the last row scanning line of the scanning line, the conduction degree of the thin film transistor corresponding to the previous row of scanning lines in the two adjacent rows is controlled and adjusted to be greater than that of the thin film transistor corresponding to the subsequent row of scanning lines in the two adjacent rows. Further, the chamfering slope of the row driving voltage waveform output on the previous row of scanning lines in the two adjacent rows is smaller than that of the row driving voltage waveform output on the scanning line adjacent thereto to achieve adjacent, in order to realize that the opening area of the thin film transistor of the previous row in the two adjacent rows is larger than that of the thin film transistor adjacent thereto, that is, the charging efficiency of the sub-pixel corresponding to the previous row of scanning lines in the two adjacent rows is increased, to compensate for the time lost due to voltage switching ramp. Therefore, the charging efficiency of the sub-pixel corresponding to the previous row of scanning lines in the two adjacent rows is consistent with that of the sub-pixel corresponding to the even-numbered row of scanning lines. In this way, it is advantageous to switch the voltage of the data signal from the positive polarity to the negative polarity, or to switch from the negative polarity to the positive polarity, to ensure that the charging effect of each sub-pixel is the same and the lightness is uniform. The present disclosure solves the problem that when the data signal voltage undergoes the polarity inversion, the cross-voltage is relatively large, resulting in a difference in charge saturation between two adjacent sub-pixels sharing a data line where the problem of the low gray-scale bright and dark line appears. The application improves the image quality of the display device.

### BRIEF DESCRIPTION OF THE DRAWINGS

In order to illustrate the technical schemes in the embodiments of the present disclosure or in the prior art more clearly, the drawings which are required to be used in the description of the embodiments of the present disclosure or the prior art are briefly described below. It is obvious that the drawings described below are only some embodiments of the present disclosure. It is apparent to those of ordinary skill in the art that other drawings may be obtained based on the structures shown in accompanying drawings without inventive effort.

FIG. 1 is a schematic diagram of functional modules of a preferred embodiment of a drive circuit of a display panel of the present application applied to a display device;

FIG. 2 is a schematic diagram showing the circuit structure of an embodiment of a chamfered circuit in the gate drive circuit of FIG. 1;

FIG. 3 is a schematic view of an embodiment of a Dual-gate in a display device of the present application;

FIG. 4 is a schematic view of another embodiment of a Dual-gate in a display device of the present application;

FIG. 5 is a schematic flow chart of an embodiment of a gate driving method for a Dual-gate of the present application applied to a display device.

The object realization, function characteristics and advantages of this application will be further described in reference to embodiments and accompanying drawings.

### DETAILED DESCRIPTION OF THE EMBODIMENTS

The technical solutions in the embodiments of the present application will be clearly and completely described hereafter in reference to the drawings in the embodiments of the present application. It is apparent that the described embodiments are merely a part of embodiments rather than all the embodiments of the present application. All the other embodiments obtained by the artisans concerned on the basis of the embodiments in the present application without creative efforts fall within the scope of claims of the present application.

It is to be understood that, all of the directional instructions in the exemplary embodiments of the present disclosure (such as top, down, left, right, front, back) can only be used for explaining relative position relations, moving condition of the elements under a special form (referring to figures), and so on, if the special form changes, the directional instructions changes accordingly.

In addition, the descriptions, such as the “first”, the “second” in the present application, are only used for descriptive purpose, and cannot be understood as indicating or suggesting relative importance or impliedly indicating the number of the indicated technical features. Therefore, the character indicated by the “first”, the “second” can explicitly or implicitly include at least one feature. Additionally, the technical solution of each embodiment can be combined with each other on the condition that it can be realized by ordinary artisans concerned; if the combination of technical solution contradicts each other or cannot be realized, it should be regarded that the combination of such solution does not exist, nor is it in the protection scope required by the present application.

The present application proposes a drive circuit for a display panel, which should be provided in a display device.

In the present embodiment, the display device may be a display device having a liquid crystal display such as a computer display screen, a mobile phone, a monitor, or a television. The display device includes a display panel 100; a timing controller 200 configured to output a first timing control signal and a second timing control signal; a driving power supply 300 configured to output a gate turn-on voltage and/or a gate turn-off voltage, and a gate drive circuit 400.

The display device further includes a source drive circuit 500. The timing controller 200 is respectively connected to the gate drive circuit 400, the source drive circuit 500, and the driving power supply 300. The timing controller 200 is configured to receive a data signal, a control signal and a clock signal output by the external circuit module and is converted into a data signal, a control signal, and a clock signal suitable for the gate drive circuit 400 and the source drive circuit 500 to realize image display of the liquid crystal panel. The signal format input by the timing controller 200 is generally in the form of a transistor-transistor logic (TTL) signal, a low voltage differential signaling (LVDS), an embedded display (eDP) signal, and a V-by-One signal, etc. The control signal output by the timing controller 200 includes a gate control signal and a source control signal, and the source drive signal includes a Start Horizontal (STH), a Clock Pulse Horizontal (CPH), a data output signal (TP) and data polarity reversal signal (MPOL or POL). The gate drive signals include a Start Vertical (STV), a Clock Pulse Vertical (CPV), and an Output Enable (OE).

The driving power supply 300 is integrated with a plurality of DC-DC conversion circuits of different circuit functions, each of the DC-DC conversion circuits outputting a different voltage value. The voltage input to the input end of the driving power supply 300 is generally 5V or 12V, and the output voltage includes the operating voltage DVDD supplied to the timing controller 200, and the gate-on voltage Vgh and the turn-off voltage supplied to the gate drive circuit 400.

The display area is composed of a plurality of pixels, and each pixel is composed of three sub-pixels of red, green and blue. Each sub-pixel is composed of a thin film transistor and a capacitor. A plurality of odd-numbered rows and a plurality of even-numbered rows of thin film transistors and capacitors may constitute the display panel 100. Among which, a plurality of thin film transistors constitute a switch array.

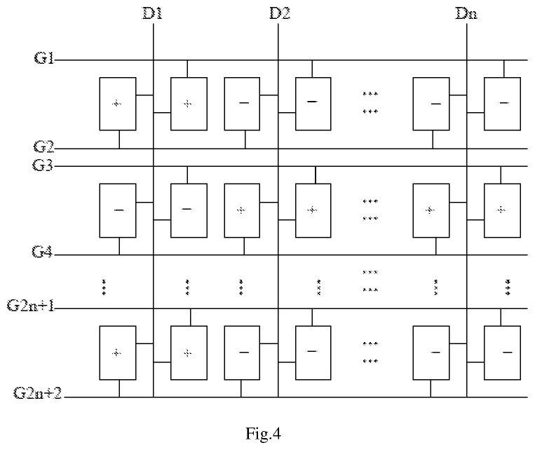

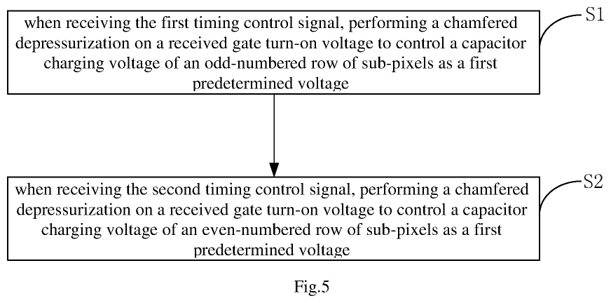

Referring to FIGS. 3 and 4, which show two embodiments of the display panel 100. In the display panel 100, as shown in FIG. 3, the thin film transistors of the odd-numbered columns in each row are respectively connected to the odd-numbered rows of scanning lines, and the thin-film transistors of the even-numbered columns in each row are electrically connected to the even-numbered rows of scanning lines respectively, and adjacent odd-numbered columns of thin film transistors and the even-numbered columns of thin film transistors are electrically connected to the same data line. Alternatively, as shown in FIG. 4, the thin film transistors of the odd-numbered columns in each row are respectively connected to the odd-numbered rows of scanning lines, and the thin-film transistors of the even-numbered columns in each row are electrically connected to the even-numbered rows of scanning lines respectively, and adjacent odd-numbered columns of thin film transistors and the even-numbered columns of thin film transistors are electrically connected to the same data line.

It should be noted that, according to the number of rows opened and the input of the corresponding pixel signal at a certain moment, the pixel driving structure can be divided into a 1G1D structure in which only one row is opened at a time, a 2G2D structure in which two rows are simultaneously opened at a certain time, and a Dual-gate. This embodiment is preferably implemented by using a Dual-gate. Since the row scanning line is doubled in the display panel 100, and the data line is halved, accordingly, the number of integrated chips in the gate drive circuit 400 is doubled, and the number of integrated chips in the source drive circuit 500 can be halved. Since the manufacturing cost of the integrated chip in the source drive circuit 500 is much higher than that of the integrated chip in the gate drive chip, the Dual-gate can effectively reduce the production cost of the display device.

Compared with the 1G1D structure, in the Dual-gate, the row write time will be reduced to half of the original, while in the design of the liquid crystal display panel, an important factor in considering the pixel driving structure is to ensure that the pixel has sufficient pixel charging rate, and the shortening of the row write time will affect the pixel charging rate. In order to ensure high pixel charging rate and good image quality, the display panel usually uses 1+2 line or 2 Line Inversion method to drive the polarity inversion of the capacitor in the pixel array.

Since the display panel 100 drives the polarity inversion of the capacitor in the pixel array by using the 2 line or 1+2 line polarity inversion method, the realization of the AC drive of the liquid crystal molecules means that the potential of the other electrode of the capacitor is changed from high to low with respect to the common electrode potential in the case where the common electrode potential remains unchanged. That is, the data signal output from the source drive circuit 500 is raised or lowered with respect to the common electrode voltage. While during the process that the data signal voltage is raised relative to the common electrode voltage so as to be switched from the negative polarity voltage to the positive polarity voltage, or decreased to achieve the switching from the positive polarity voltage to the negative polarity, the voltage across the data signal voltage is relatively large, and the voltage switching requires ramp time due to RC load. Therefore, in the case where the charging time is constant, the charging rate of the sub-pixels during the ramp time (that is, needs to experience voltage switching) is lower than that of the sub-pixels whose voltages tend to be stable, that is, the saturation of the pixel charging of the former is smaller than that of the latter, while the lightness of the pixel that is saturated is greater than that of the pixel that is not fully saturated. For example, in the display panel 100 of the present embodiment, the adjacent odd-numbered columns of thin film transistors and the even-numbered columns of thin film transistors are electrically connected to the same data line, and the gates of the adjacent odd-numbered columns of thin film transistors and even-numbered columns of thin film transistors are controlled by two adjacent scanning lines respectively. For example, the color sub-pixels located in the first column of the first row and the sub-pixels located in second column of the first row. The gate of the sub-pixel located in the first column of the first row is connected to the scanning line G1, the source is connected to the data line D2, while the gate of the sub-pixel located in the second column of the first row is connected to the scanning line G2, and the source is connected to the data line D2. The two adjacent sub-pixels have the same polarity when using the 2Line Inversion, or the first row of the scanning line has a single polarity, and the two adjacent sub-pixels in the scanning scan lines have the same polarity when the polarity is inversed by using 1+2 Line Inversion. In the present embodiment, a 2Line Inversion method will be described as an example. When the gate drive circuit 420 scans row by row, the G1 row scanning line is turned on first, and the G2 row scanning line is turned on later; while in the 1+2Line Inversion method, the G2 row scanning line is turned on first, and the G3 row scanning line is turned on later. The polarity of the color sub-pixel in the first column of the first row is inversed from the positive electrode to the negative electrode. During the charging process of the color sub-pixels in the first column of the first row, the data voltage on the data line D2 is gradually lowered from the high level to the low level, that is, switched from the positive electrode to the negative electrode and remains at the low level. The voltage across the data signal now is relatively large. When the color sub-pixels in the first column of the first row are charged, they are not charged and saturated. After the color sub-pixels in the first row of the first row are charged, the G1 row scanning line is turned off, and the G2 row scanning line is turned on, thereby charging the sub-pixels of the second column of the first row. While during the charging of the sub-pixels of the second column of the first row, the data voltage on the data line D2 is kept at a low level, which is equivalent to switching from the negative electrode to the negative electrode. At this time, the voltage across the data signal is small or there is no voltage across it, so the saturation is higher when the charging of the blue sub-pixel is completed. Thus, the lightness of the color sub-pixels of the second column of the first row will be higher than that of the color sub-pixels of the first column of the first row, and a problem of light/dark lines will appear on the entire liquid crystal panel in the same manner.

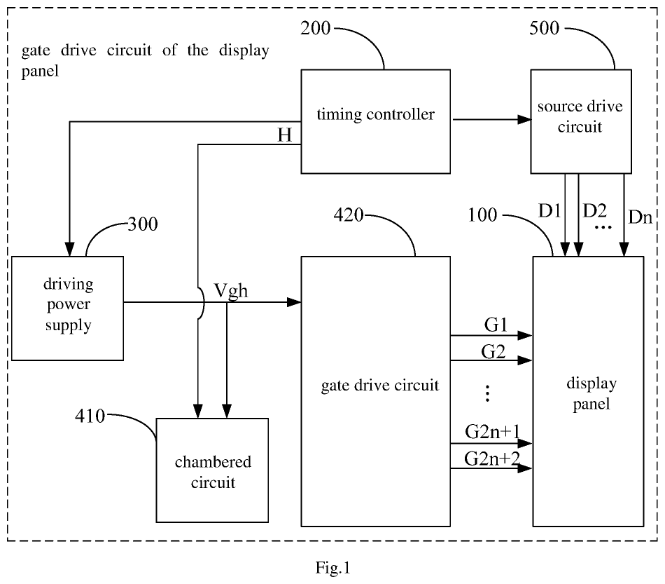

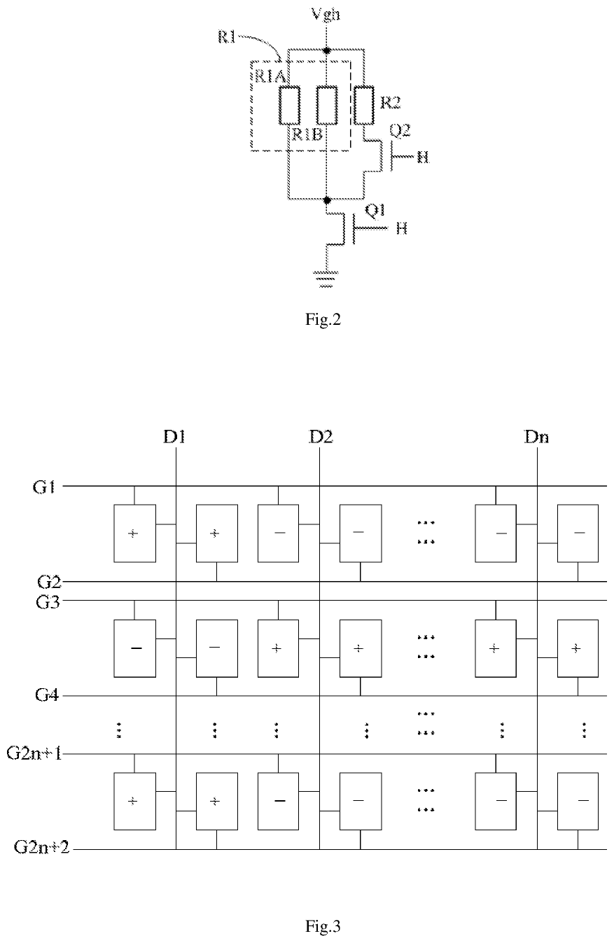

In order to solve the above problem, referring to FIG. 1 and FIG. 2, in an embodiment of the present application, the drive circuit of the display panel includes:

a gate drive circuit 420 configured to receive a gate turn-on voltage Vgh of the driving power supply 300 to drive corresponding odd-numbered rows in the display panel 100,

a chamfered circuit 410 configured to, when receiving the first timing control signal, perform a chamfered depressurization on a gate turn-on voltage Vgh output to the gate drive circuit 420 by the driving power supply 300 to control a capacitor charging voltage of an odd-numbered row of sub-pixels as a first predetermined voltage; when receiving the second timing control signal, the gate drive circuit performs a chamfered depressurization on the gate turn-on voltage Vgh of the driving power supply 300 output to the gate drive circuit 420 to control a capacitor charging voltage of an even-numbered row of sub-pixels to be equal to the first predetermined voltage.

In the present embodiment, the output end of the driving power supply 300 is connected to the input ends of the gate drive circuit 420 and the chamfered circuit 410, and the control end of the timing controller 200 is connected to the controlled ends of the chamfered circuit 410 and the gate drive circuit 420 respectively. The odd-numbered row scanning lines are G1, G3, G5 . . . G2n+1, and the even-numbered row scanning lines are G2, G4, G6 . . . G2n+2. Based on the control of the Start Vertical (STV), the Clock Pulse Vertical (CPV), and the Output Enable (OE) output by the timing controller 200, and when the driving power supply 300 outputs the gate turn-on voltage Vgh, the gate drive circuit 420 drives the corresponding thin film transistors in the row of the switch array G1 to the G2n+2 row to be turned on line by line through each row of scanning lines, in order to cooperate with the data-driven integrated circuit under the action of the control signal output by the timing controller 200, the data signal of the open row would be input into the corresponding pixel, and the corresponding thin film transistor in the switch array would be turned off when the driving power supply 300 outputs the turn-off voltage. When the gate drive circuit 420 drives the switch array to turn on row by row at a time, all the column data signal lines transmit data signals to the row of sub-pixels, charge the sub-pixel capacitors, and realize the signal voltage write and holding of the pixels. The liquid crystal molecules in the sub-pixel region rotate at this voltage, so that the transmittance of the incident light passing through the liquid crystal molecules is changed, that is, the light valve action on the incident light is realized.

The chamfered circuit 410 performs a chamfered depressurization on the gate turn-on voltage Vgh when receiving the first timing control signal output by the timing controller 200; to control a capacitor charging voltage of a previous row of sub-pixels in two adjacent rows as a first predetermined voltage; when receiving the second timing control signal, performing a chamfered depressurization on the gate turn-on voltage Vgh output to the gate drive circuit 420 by the driving power supply 300 to control a capacitor charging voltage of a subsequent row of sub-pixels in two adjacent rows to be equal to the first predetermined voltage. Among which, the first timing control signal and the second timing control signal are both square signals whose high and low levels alternate, and the chamfered circuit 410 starts chamfering when the square signals of the first timing control signal and the second timing control signal is at a high level H, and stops chamfering when the square signals of the first timing control signal and the second timing control signal is at a low level.

In the present application, when the timing controller 200 outputs a control signal to the gate drive circuit 420, and when the driving power supply 300 outputs the gate turn-on voltage Vgh to the gate drive circuit 420 to drive the gate drive circuit 420 to operate, the timing controller 200 outputs the first timing control signal and the second timing control signal to the chamfered circuit 410 respectively to control the chamfered circuit 410 to perform a chamfered depressurization on the gate turn-on voltage Vgh. Therefore, in the process that the gate drive circuit 420 outputs the corresponding row scanning signal to the thin film transistor via the row scanning line to realize the row-by-row opening from the first row scanning line to the last row scanning line of the scanning line, the conduction degree of the thin film transistor corresponding to the previous row of scanning lines in the two adjacent rows is controlled and adjusted to be greater than that of the thin film transistor corresponding to the subsequent row of scanning lines in the two adjacent rows. Further, the chamfering slope of the row driving voltage waveform output on the previous row of scanning lines in the two adjacent rows is smaller than that of the row driving voltage waveform output on the scanning line adjacent thereto, in order to realize that the opening area of the thin film transistor of the previous row in the two adjacent rows is larger than that of the thin film transistor adjacent thereto, that is, the charging efficiency of the sub-pixel corresponding to the previous row of scanning lines in the two adjacent rows is increased, to compensate for the time lost due to voltage switching ramp. Therefore, the charging efficiency of the sub-pixel corresponding to the previous row of scanning lines in the two adjacent rows is consistent with that of the sub-pixel corresponding to the even-numbered row of scanning lines. In this way, it is advantageous to switch the voltage of the data signal from the positive polarity to the negative polarity, or to switch from the negative polarity to the positive polarity, to ensure that the charging effect of each sub-pixel is the same and the lightness is uniform. The present disclosure solves the problem that when the data signal voltage undergoes the polarity inversion, the cross-voltage is relatively large, resulting in a difference in charge saturation between two adjacent sub-pixels sharing a data line where the problem of the low gray-scale bright and dark line appears. The application improves the image quality of the display device.

It can be understood that when the polarity is inversed in the 1+2Line Inversion method, the gate drive circuit 420 outputs the corresponding row scanning signal to the switch array via the row scanning line for scanning. The second row of the scanning line is called the previous row of the scanning line of the two adjacent rows (or called odd-numbered row), and the third row is called the subsequent row of the two adjacent rows (or called even-numbered row) and so on, until scanning to the last row of the display panel, the chamfering process thereof being the same as the polarity inversion in the 2Line Inversion method, and will not be described here.

Referring to FIGS. 1 and 2, in a preferred embodiment, the chamfered circuit 410 includes a first chamfered resistor R1, a second chamfered resistor R2, a first switch tube Q1 and a second switch tube Q2. A first end of the first chamfered resistor R1 is an input end of the chamfered circuit 410, and is connected to a first end of the second chamfered resistor. R2 A second end of the first chamfered resistor R1 is interconnected with an input end of the first switch tube Q1 and an output end of the second switch tube Q2 respectively. The output end of the first switch tube Q1 is grounded, and the controlled end of the first switch tube Q1 is the first controlled end of the first chamfered circuit 410; a second end of the second chamfered resistor R2 is connected to an input end of the second switch tube Q2, and an controlled end of the second switch tube Q2 is a second controlled end of the chamfered circuit 410.

In the present embodiment, the first switch tube Q1 and the first switch tube Q1 can adopt a MOSFET (Insulated Gate Field Effect Transistor), a TFT (Thin Film Transistor), a triode, an IGBT (Insulated Gate Bipolar Transistor) and other switch tubes. The first switch tube Q1 and the first switch tube Q1 of the present embodiment are preferably N-MOSFETs (N-type Insulated Gate Field Effect Transistor). The first chamfered resistor R1 and the second chamfered resistor R2 are both discharge resistors, and the first chamfered resistor R1 would perform a first chamfered depressurization on the gate-on voltage Vgh output to the gate drive circuit 420 by the current driving power supply 300 when the first switch tube Q1 receives the first timing control signal of high level output by the timing controller 200. It can be understood that the first chamfered resistor R1 is a divider resistance, and the first chamfered resistor R1 and the gate drive circuit 420 are equivalent to the series voltage division. The voltage division ratio of the terminal voltage of the first chamfered resistor R1 and the gate-on voltage Vgh output to the gate drive circuit 420 is adjusted by adjusting the resistance value of the first chamfered resistor R1, thereby adjusting the voltage value of the gate turn-on voltage Vgh of the gate drive circuit 420, so as to adjust the charging efficiency of the thin film transistor corresponding to the open row of the gate drive circuit 420.

The second chamfered resistor R2 is arranged in parallel with the first chamfered resistor R1, so as to perform a second chamfered depressurization on the gate-on voltage Vgh output to the gate drive circuit 420 by the current driving power supply 300 when the second switch tube Q2 receives the second timing control signal of high level output by the timing controller 200 and the first switch tube Q1 receives the first timing control signal of high level output by the timing controller 200 The first chamfered resistor R1 and the second chamfered resistor R2 arranged in parallel at this time are divider resistances, and the total resistance value of the first chamfered resistor R1 and the second chamfered resistor R2 is reduced according to the law of resistance in parallel, decrease in resistance. According to the series voltage division principle, the smaller the total resistance value of the first chamfered resistor R1 and the second chamfered resistor R2 is, the larger the voltage division is, and the voltage value of the gate turn-on voltage Vgh output to the gate drive circuit 420 at this time is smaller, thereby realizing the charging efficiency of the thin film transistor corresponding to the open row of the gate drive circuit 420. In summary, the discharge degree of the first chamfered resistor R1 is smaller than the degree of discharge when the first chamfered resistor R1 and the second chamfered resistor R2 are arranged in parallel. Therefore, in the present embodiment, when the gate drive circuit 420 drives the corresponding thin film transistor on the odd-numbered row of scanning lines to be turned on, the first switch tube Q1 is controlled to be conducted by outputting the first timing control signal of high level by the timing controller 200, thereby the first chamfered resistor R1 divides and discharges the gate turn-on voltage Vgh currently output to the gate drive circuit 420. When the gate drive circuit 420 drives the corresponding thin film transistor on each scanning line to be turned on, the first switch tube Q1 and the second switch tube Q2 are controlled to be conducted simultaneously by outputting two second timing control signals of different high levels through the timing controller 200 respectively, so that the first chamfered resistor R1 and the second chamfered resistor R2 are arranged in parallel, and the gate turn-on voltage Vgh currently output to the gate drive circuit 420 is divided and discharged so that the chamfering slope of the previous row is smaller than that of the subsequent row. Further, the opening area of the previous row is larger than that of the G2n+2 row, that is, the charging efficiency of the previous row is increased to compensate for the time lost due to the voltage switching ramp, so that the charging efficiency of the previous row is consistent with that of the subsequent row. Finally, in the 2line inversion mode, the charging efficiency of the corresponding sub-pixels on the previous row of scanning lines such as G1, G3, G5, . . . , G2n+1 is the same as that of the corresponding sub-pixels on the subsequent row of scanning lines such as G2, G4, G6, G2n+2 (in the 1+2line inversion mode, the charging efficiency of the corresponding sub-pixel on the previous row such as G2, G4, G6 . . . G2n is the same as that of the corresponding sub-pixels on the subsequent row of scanning lines such as G3, G5 . . . G2n+1). Thereby, the lightness of each sub-pixel on the entire display panel of the display device is consistent, so as to solve the problem that the sub-pixels appear bright/dark lines due to different degrees of charge saturation.

Referring to FIG. 1 and FIG. 2, in the above embodiment, the number of the first chamfered resistors R1 is plural, and a plurality of the first chamfered resistors R1 are arranged in parallel.

In the present embodiment, it can be understood that the number of the first chamfered resistors R1 may be one or more, and is preferably two in the present embodiment, and is respectively labeled as the first chamfered resistor R1A and the first chamfered resistor R1B. The first chamfered resistor R1A and the first chamfered resistor R1B are arranged in parallel. When the first switch tube Q1 is conducted, the total chamfered resistance of the first chamfered resistor R1A and the first chamfered resistor R1B is R1A*R1B/(R1A+R1B). When the first switch tube Q1 and the first switch tube Q2 is conducted, the total chamfered resistance of the first chamfered resistor R1A, the first chamfered resistor R1B and the second chamfered resistor R2 is (R1A*R1B*R2/(R1A*R1B+R1A*R2+R1B*R2). The arrangement is such that when the thin film transistors corresponding to the different rows of scanning lines are turned on, the chamfered slopes of the gate turn-on voltage Vgh of the corresponding rows of scanning lines are controlled to be different, which is advantageous for improving the lightness uniformity of the sub-pixels corresponding to each row of scanning lines.

It can be understood that since the drive circuit for the display panel described above is used in the display device of the present application, the embodiments of the display device of the present application include all the technical solutions of all the embodiments of the drive circuit for the display panel described above, and the technical effects achieved are also completely the same, and will not be repeated here.

The present application further proposes a driving method of a display panel, referring to FIG. 5, the method includes:

step S1. when receiving the first timing control signal, performing a chamfered depressurization on a received gate turn-on voltage to control a capacitor charging voltage of a previous row of sub-pixels in two adjacent rows as a first predetermined voltage;

step S2. when receiving the second timing control signal, performing a chamfered depressurization on a received gate turn-on voltage to control a capacitor charging voltage of a subsequent row of sub-pixels in two adjacent rows to be equal to the first predetermined voltage.

It can be understood that, before step S1 is performed, step S2 may be performed first, and those skilled in the art may set up according to the chamfered circuit and the polarity inversion type adopted in order to achieve the charging rate of the two adjacent rows of pixel capacitors to be the same when charging the pixel capacitor, which is not defined herein.

Among which, the step of performing a chamfered depressurization on the gate turn-on voltage output to the gate drive circuit includes:

performing different levels of voltage division on the gate turn-on voltage output to the gate drive circuit according to the received first timing control signal or the second timing control signal, to perform a chamfered depressurization on the gate turn-on voltage.

The first timing control signal and the second timing control signal are both square signals whose high and low levels alternate, and starts chamfering when the square signals of the first timing control signal and the second timing control signal is at a high level H, and stops chamfering when the square signals of the first timing control signal and the second timing control signal is at a low level.

In the present application, when the timing controller outputs a control signal to the gate drive circuit, and when the driving power supply outputs gate turn-on voltage to the gate drive circuit to drive the gate drive circuit to operate, the timing controller outputs the first timing control signal and the second timing control signal to the chamfered circuit respectively, in order to control the chamfered circuit to perform the chamfered depressurization on the gate turn-on voltage, so that in the process that the gate drive circuit outputs the corresponding row scanning signal to the thin film transistor via the row scanning line to realize the row-by-row opening from the first row scanning line to the last row scanning line of the scanning line, the conduction degree of the thin film transistor corresponding to the previous row of scanning lines in two rows is controlled and adjusted to be greater than that of the thin film transistor corresponding to the subsequent row of scanning lines in the two rows. Further, the chamfering slope of the row driving voltage waveform output on the previous row of scanning lines is smaller than that of the row driving voltage waveform output on the scanning line, in order to realize that the opening area of the thin film transistor of the previous row is larger than that of the thin film transistor adjacent thereto, that is, the charging efficiency of the sub-pixel corresponding to the previous row of scanning lines is increased, to compensate for the time lost due to voltage switching ramp, so that the charging efficiency of the sub-pixel corresponding to the previous row of scanning lines is consistent with that of the sub-pixel corresponding to the even-numbered row of scanning lines. In this way, it is advantageous to switch the voltage of the data signal from the positive polarity to the negative polarity, or to switch from the negative polarity to the positive polarity, to ensure that the charging effect of each sub-pixel is the same and the lightness is uniform. The present disclosure solves the problem that when the data signal voltage undergoes the polarity inversion, the cross-voltage is relatively large, resulting in a difference in charge saturation between two adjacent sub-pixels sharing a data line where the problem of the low gray-scale bright and dark line appears. The application improves the image quality of the display device.

The embodiments above are merely preferred embodiments of the present disclosure but are not to be construed as limiting the patent scope of the present disclosure, and any equivalent structural conversion devised based on the inventive concept of the present disclosure or using the drawing of the present disclosure, or a direct or indirect application of the present disclosure to another related technical field shall fall into the scope of protection of the present disclosure.

What is claimed is:

1. A drive circuit of a display panel, the display panel having a plurality of sub-pixels; wherein the drive circuit of the display panel comprises:
a timing controller configured to output a first timing control signal and a second timing control signal;
a driving power supply configured to output gate turn-on voltage and/or gate turn-off voltage;
a gate drive circuit configured to receive a gate turn-on voltage of the driving power supply to drive a corresponding row of sub-pixels;
A chamfered circuit configured to, when receiving the first timing control signal, perform a chamfered depressurization on a gate turn-on voltage of the driving power output to the gate drive circuit to control a capacitor charging voltage of a previous row of sub-pixels in two adjacent rows as a first predetermined voltage; when receiving the second timing control signal, the gate drive circuit performs a chamfered depressurization on the gate turn-on voltage of the driving power supply output to the gate drive circuit to control a capacitor charging voltage of a subsequent row of sub-pixels in two adjacent rows to be equal to the first predetermined voltage.

2. The drive circuit of the display panel according to claim 1, wherein the chamfered circuit comprises a first chamfered resistor, a second chamfered resistor, a first switch tube and a second switch tube. A first end of the first chamfered resistor is an input end of the chamfered circuit, and is connected to a first end of the second chamfered resistor. A second end of the first chamfered resistor is interconnected with an input end of the first switch tube and an output end of the second switch tube respectively. The output end of the first switch tube is grounded, and the controlled end of the first switch tube is the first controlled end of the first chamfered circuit; a second end of the second chamfered resistor is connected to an input end of the second switch tube, and an controlled end of the second switch tube is a second controlled end of the chamfered circuit.

3. The drive circuit of the display panel according to claim 2, wherein the number of the first chamfered resistors is plural, and a plurality of the first chamfered resistors are arranged in parallel.

4. The drive circuit of the display panel according to claim 2, wherein the first switch tube and/or the first switch tube are N-MOS transistors.

5. The drive circuit of the display panel according to claim 2, wherein the first switch tube and/or the first switch tube are triodes.

6. The drive circuit of the display panel according to claim 2, wherein the first switch tube and/or the first switch tube are IGBT (Insulated Gate Bipolar Transistor).

7. A display device comprising a display panel having a plurality of sub-pixels, a timing controller and a driving power supply, the timing controller being configured to output a first timing control signal and a second timing control signal; wherein the display device further comprises the drive circuit of the display panel; the drive circuit of the display panel comprises:
a gate drive circuit configured to receive a gate turn-on voltage of the driving power supply to drive a corresponding row of sub-pixels to operate in the Dual-gate;
a chamfered circuit configured to, when receiving the first timing control signal, perform a chamfered depressurization on a gate turn-on voltage of the driving power output to the gate drive circuit to control a capacitor charging voltage of a current row of sub-pixels as a first predetermined voltage; when receiving the second timing control signal, the gate drive circuit performs a chamfered depressurization on the gate turn-on voltage of the driving power supply output to the gate drive circuit to control a capacitor charging voltage of an even-numbered row of sub-pixels to be equal to the first predetermined voltage.

8. The display device according to claim 7, wherein the Dual-gate comprises a switch array; the drive circuit of the display panel further comprises a plurality of data lines and a plurality of scanning lines electrically connected to the gate drive circuit, and the switch array comprises a plurality of thin film transistors. The thin film transistors of the odd-numbered columns in each row are respectively connected to the odd-numbered rows of scanning lines, and the thin-film transistors of the even-numbered columns in each row are electrically connected to the even-numbered rows of scanning lines respectively, and adjacent odd-numbered columns of thin film transistors and the even-numbered columns of thin film transistors are electrically connected to the same data line.

9. The display device according to claim 7, wherein the Dual-gate comprises a switch array; the drive circuit of the display panel further comprises a plurality of data lines and a plurality of scanning lines electrically connected to the gate drive circuit, and the switch array comprises a plurality of thin film transistors. The thin film transistors of the odd-numbered columns in each row are respectively connected to the odd-numbered rows of scanning lines, and the thin-film transistors of the even-numbered columns in each row are electrically connected to the even-numbered rows of scanning lines respectively, and adjacent odd-numbered columns of thin film transistors and the even-numbered columns of thin film transistors are electrically connected to the same data line.

10. The display device according to claim 7, wherein the way of the polarity inversion of the switch array is a 1+2 Line Inversion.

11. The display device according to claim 7, wherein the way of the polarity inversion of the switch array is a 2 Line Inversion.

12. The display device according to claim 7, wherein the chamfered circuit comprises a first chamfered resistor, a second chamfered resistor, a first switch tube and a second switch tube. A first end of the first chamfered resistor is an input end of the chamfered circuit, and is connected to a first end of the second chamfered resistor. A second end of the first chamfered resistor is interconnected with an input end of the first switch tube and an output end of the second switch tube respectively. The output end of the first switch tube is grounded, and the controlled end of the first switch tube is the first controlled end of the first chamfered circuit; a second end of the second chamfered resistor is connected to an input end of the second switch tube, and an controlled end of the second switch tube is a second controlled end of the chamfered circuit.

13. The display device according to claim 12, wherein the number of the first chamfered resistors is plural, and a plurality of the first chamfered resistors are arranged in parallel.

14. The drive circuit of the display panel according to claim 7, wherein the first switch tube and/or the first switch tube are N-MOS transistors.

15. The display device according to claim 7, wherein a plurality of the scanning lines comprise odd-numbered rows of scanning lines and even-numbered rows of scanning lines.

16. The display device according to claim 7, wherein the display device further comprises a source drive circuit, wherein the timing controller is connected to the gate drive circuit, the source drive circuit, and the driving power supply respectively.

17. The display device of claim 7, wherein the driving power supply is integrated with a plurality of DC-DC conversion circuits of different circuit functions, each of the DC-DC conversion circuits outputting a different voltage value.

18. A driving method of a display panel, the display panel comprises a plurality of sub-pixels; wherein the driving method of the display panel comprises:
when receiving the first timing control signal, performing a chamfered depressurization on a received gate turn-on voltage to control a capacitor charging voltage of a previous row of sub-pixels in two adjacent rows as a first predetermined voltage;
when receiving the second timing control signal, performing a chamfered depressurization on a received gate turn-on voltage to control a capacitor charging voltage of a subsequent row of sub-pixels in two adjacent rows to be equal to the first predetermined voltage.

19. The driving method of the display panel according to claim 18, wherein the step of performing a chamfered depressurization on the gate turn-on voltage output to the gate drive circuit comprises:
performing different levels of voltage division on the gate turn-on voltage output to the gate drive circuit according to the received first timing control signal or the second timing control signal, to perform a chamfered depressurization on the gate turn-on voltage.
